(19) United States
(12) Patent Application Publication
(10) Pub. No.: US 2012/0020606 A1
(43) Pub. Date: Jan. 26, 2012

(54) CAGE FOR ROLLER BEARING

(76) Inventors: Bruno Montboeuf, Cerelles (FR); Richard Corbett, Fondettes (FR); Christophe Houdayer, Semblancay (FR); Samuel Viault, Tours (FR); Jéröme Dubus, La Riche (FR)

(21) Appl. No.: 13/147,387

(22) PCT Filed: Feb. 3, 2010
(86) PCT No.: PCT/EP2010/051274

§ 371 Date: Aug. 2, 2011

(30) Foreign Application Priority Data
Feb. 5, 2009 (FR) 0950731

(51) Int. Cl. F16C 33/76; F16C 33/44

(52) U.S. Cl. 384/607

(57) ABSTRACT

A cage (10) for holding rolling elements (9) of a roller bearing (6) comprises a frame part (15) holding the rolling elements (9) on a bearing circumference (17), and at least one circumferential sealing lip (16c, 16d) extending from the frame (15), made of a more pliable material than the material of the frame. The frame (15) has parts comprising concave surfaces (38). The material of the circumferential lip at least partly fills the concavities (25) defined by these concave surfaces.

The present invention relates to the field of roller bearings, and more particularly to the field of cages for holding the rolling elements of such bearings. These roller bearings can be of the axial bearing type (thrust-type bearings), or of the concentric races type.

In the axial configuration, these bearings can especially be used in axial suspension stop devices of suspension legs of steered wheels of a motor vehicle. Traditionally, a suspension stop comprises a roller bearing provided with an upper race, a lower race and rolling elements, held by a cage, disposed between the two races, resting axially on each of the races and travelling on these same, as well as upper and lower bearing or supporting elements, such as caps, forming receptacles for the lower and upper races of the bearing, respectively.

A suspension stop is disposed in the upper part of the suspension leg between a suspension spring and an upper element fixedly connected to the body of the vehicle. The suspension spring is disposed around a shock absorber piston rod, the end of which can be fixedly connected to the body of the vehicle. The spring comes axially to bear, directly or indirectly, upon the lower supporting cap of the roller bearing. In the remainder of the text, the roller bearing will sometimes be denoted by the simplified term “bearing”.

The suspension stop thus allows the transmission of axial forces between the suspension spring and the body of the vehicle, whilst permitting a relative angular motion between the lower cap, which is rotationally movable, and the upper cap. This relative angular motion can derive from turning of the steered wheels and/or from the compression of the suspension spring.

The inside of the bearing, that is to say the space between the two races, contains a lubricant. For the correct working of the bearing, it is expedient to retain the lubricant inside the bearing, and at the same time prevent the penetration of pollutants, whether solid or liquid, inside the bearing. For this purpose, seals can be disposed at the junction between the two races. These seals can be fixed either to one of the races, or to the cage for holding the rolling elements. In this latter case, bulky and sometimes costly slide systems are spared when it is a case of machining them into one or other of the races. Moreover, the angular velocity of the cage in relation to the fixed race is about half the angular velocity of the turning race of the bearing. The speed of wear of a seal fixedly connected to the cage, and rubbing on one or the other race, is less than that of a seal fixed on one of the races and rubbing on the other race.

Japanese patent application JP 2006 322556 describes an axial roller bearing of this kind, having a metal cage on which are assembled radial double lips comprising two half-lips placed one upon the other, the axial section of which is a “V”, the point of which is attached to the cage. The end of each half-lip comes into frictional circumferential contact with a rim of one of the races, the support between the half-lip and the race being substantially radial.

This solution is difficult to implement, since, in the event of a radial misalignment of the lower cap in relation to the upper cap due, for example, to production tolerances, a friction torque of the bearing is obtained which is different from that envisaged in the uninstalled state of the bearing. This parasite friction, non-uniform over the circumference of the bearing, can give rise to an undesirable generation of noise and a premature wearing of the friction lips. Moreover, the considerable circumferential stresses between the lips and the metal cage can separate the lips from the cage.

French patent application FR 2 779 096 describes an axial roller bearing provided with a synthetic material cage, which extends on one side or two sides through one or more sealing lips rubbing on the lower race, on the upper race, or on the upper cap. The sealing contacts of the lips are realized, at least in part, with skewed surfaces, that is to say at the level of the tolerances of sectional variation of the contacted part. This solution is no more entirely satisfactory, since, in case of radial displacement of the upper part of the bearing in relation to the lower part of the roller bearing, the sealing lip, relatively rigid since being made of the same material as the central part of the holding cage, no longer ensures the desired leak-tightness on one side of the bearing, and on the other side of the bearing is subjected to friction forces which are substantially more considerable than envisaged. These non-symmetrical frictions will give rise to radial vibrations of the roller bearing.

The object of the invention is to propose a cage for a bearing, especially for a suspension stop, for which the sealing performances of the lips of the cage are ensured, even in case of partial misalignment of the upper race in relation to the lower race, limiting the risks of the lips tearing off from the cage, at an interesting production cost, and with an optimal sealing performance.

The subject of the invention is a cage for holding the rolling elements of a roller bearing. The cage comprises a frame part, which holds the rolling elements on a bearing circumference, and at least one circumferential sealing lip, made of a more pliable material than the material of the frame and extending from a zone of attachment to the frame. The cage can have a plurality of lips. At least one lip extends from its zone of attachment to the frame, towards the inside or outside of the bearing circumference, so as to distance itself from the bearing circumference when the lip moves away from the frame. The frame has concave surface parts defining concavities of axial opening, and the material of the circumferential lip at least partly fills the concavities defined by these concave surfaces. In this way, the mechanical cling fastening of the lips to the frame is improved with respect to radial tear-off forces, as well as with respect to tangential tear-off forces.

According to one embodiment, the cage comprises two lips extending axially from the frame on either side of the bearing circumference.

According to another preferred embodiment, the cage comprises at least one lip extending from the frame towards the inside of the bearing circumference, and at least one lip extending from the frame towards the outside of the bearing circumference.

According to another preferred embodiment, the cage comprises at least one circumferential sealing lip, extending from the frame towards the inside or outside of the bearing circumference, and the frame of the cage is axially traversed by orifices disposed on a circumference inside and/or on a circumference outside the bearing circumference, the said orifices being at least partly filled by the material of the circumferential lip.

Advantageously, the cage is realized by moulding one or more circumferential lips over the frame.

Advantageously, the frame comprises intermediate insert elements separating the rolling elements and two first groups of lateral elements connecting the intermediate elements and defining receptacles for the rolling elements, in which receptacles the rolling elements are held on the bearing circumference. In this configuration, the cage can comprise at least one lip fixed, by a continuous cling fastening layer, to one of the groups of lateral elements. The lip can be split in two, in the sense that the cling fastening layer can separate into two lips which axially diverge as the radial distance from the bearing circumference widens. The lip can likewise be a single-layer lip, but having a plurality of circumferential folds. Certain, or all, of the intermediate elements can be constituted by a full volume of axial dimension greater than the axial dimension of the lateral elements. The guidance of the rolling elements is thus improved in relation to a cage of constant axial thickness. The axial dimension of an intermediate insert element can likewise be greater than the thickness of the insert element, that is to say greater than the smallest distance separating two rolling elements. Both a good distribution of forces (raised number of rolling elements) and a good guidance of the rolling elements are thus obtained. The lateral elements can delimit a part of the contour of axial openings made in the frame, these openings being separated, by the lateral elements, from the receptacles of the rolling elements. A third group of lateral elements can be connected to one or other first group of lateral elements, so as to define with this first group the complete contour of the axial openings.

In one embodiment, the cling fastening layer is substantially radial and separates into two distinct lips. One of the two lips can then extend in a substantially axial direction. In this case, the moulding of the double lip is facilitated. In another construction variant, the axial section of the two lips can form a “Y”, the foot of which is the cling fastening layer to the frame, each branch of the “Y” forming an angle of amplitude of less than 90° with the radial direction. In this case, the wearing of the lip, or the irregularities of the antagonistic contact surface, can be compensated by an elastic stretching of the lip towards its bearing surface. In another embodiment, the cling fastening layer can extend radially towards the inside or outside of the bearing circumference, forming a lip having a plurality of circumferential folds. This variant is easier to produce by moulding methods than a “Y-shaped” lip, and likewise allows the wearing of the lip or the irregularities of the antagonistic contact surface to be compensated, by an elastic deformation of the lip.

Advantageously, the material of the circumferential lip(s) is a thermoplastic elastomer, the melting temperature of which is less than the melting temperature of the material of the frame.

The frame can be made of material having a matrix of polyamide, polybutylene terephthalate or polypropylene, charged or not, and the circumferential lip(s) can be made of thermoplastic polyurethane.

According to another variant, the cage can comprise a metal frame and one or more circumferential lips made of thermoplastic elastomer or cross-linkable elastomer.

According to another aspect, a roller bearing, especially for a motor vehicle suspension stop, comprises an upper race, a lower race, rolling elements between the two races, resting axially on each of the races and travelling on these same, and an inventive cage for holding these rolling elements.

According to yet another aspect, a motor vehicle suspension stop comprises an upper cap, fixedly connected to the chassis of the vehicle, a supporting seat resting directly or indirectly on a spring of the vehicle suspension, and a roller bearing according to the invention, interposed between the upper cap and the supporting seat.

Advantageously, at least one of the lips of the cage is a double lip of “Y-shaped” axial section, the two arms of the “Y” being in sealing contact with two mutually facing radial surfaces. In this case, the elasticity of the two branches of the “Y” allows a constant sealing contact to be maintained with axial surfaces facing these lips, despite the wearing of the lips and despite possible angular oscillations of the upper part of the bearing in relation to the lower part.

According to a preferred embodiment, the cage comprises at least one lip extending towards the inside of the bearing circumference, the said lip being in sealing contact with the upper cap, and comprises at least one other lip extending towards the outside of the bearing circumference, the said other lip being in sealing contact with the upper cap. In this configuration, the upper race is isolated from the environment external to the bearing, which allows costly protective surface treatments upon this race, for example anti-rust treatments, to be spared.

According to another preferred embodiment, combinable with the preceding embodiment, the cage comprises at least one lip extending towards the inside of the bearing circumference, the said lip being in sealing contact with the supporting seat, and comprises at least one other lip extending towards the outside of the bearing circumference, the said other lip being in sealing contact with the supporting seat. In this configuration, the lower race is isolated from the environment external to the bearing, which allows the costly protective surface treatments upon this race to be spared.

According to another advantageous construction variant, all the lips are in sealing contact with the upper race, or with the lower race. Owing to the good surface hardness and low surface roughness of the races, the wearing of the lip seals is then less than if the elastomeric lips rub on a surface made of plastics material, such as the plastics materials which often make up the upper cap or the supporting seat.

Advantageously, the lower part of the upper cap comprises a circumferential channel suitable for covering the upper circumference of the supporting seat, including the upper race of the bearing and at least a part of the lower race of the bearing, at least one lip being in frictional contact with a radial surface portion of the channel, inside the channel.

The present invention will be better understood from a reading of the detailed description of embodiments adopted by way of non-limiting examples and illustrated by the appended drawings, in which:

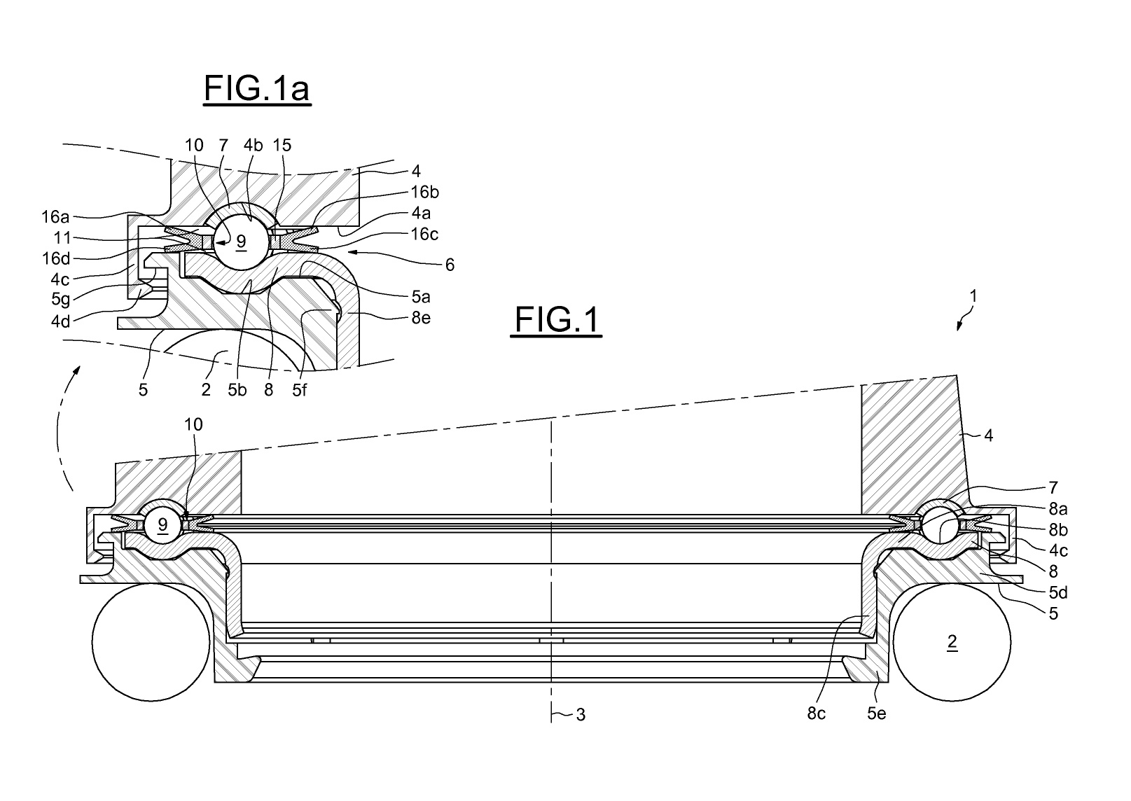

FIG. 1 is a view in axial section of a suspension stop device according to a first embodiment of the invention,

FIG. 1a is a detail of a part situated on the left in FIG. 1,

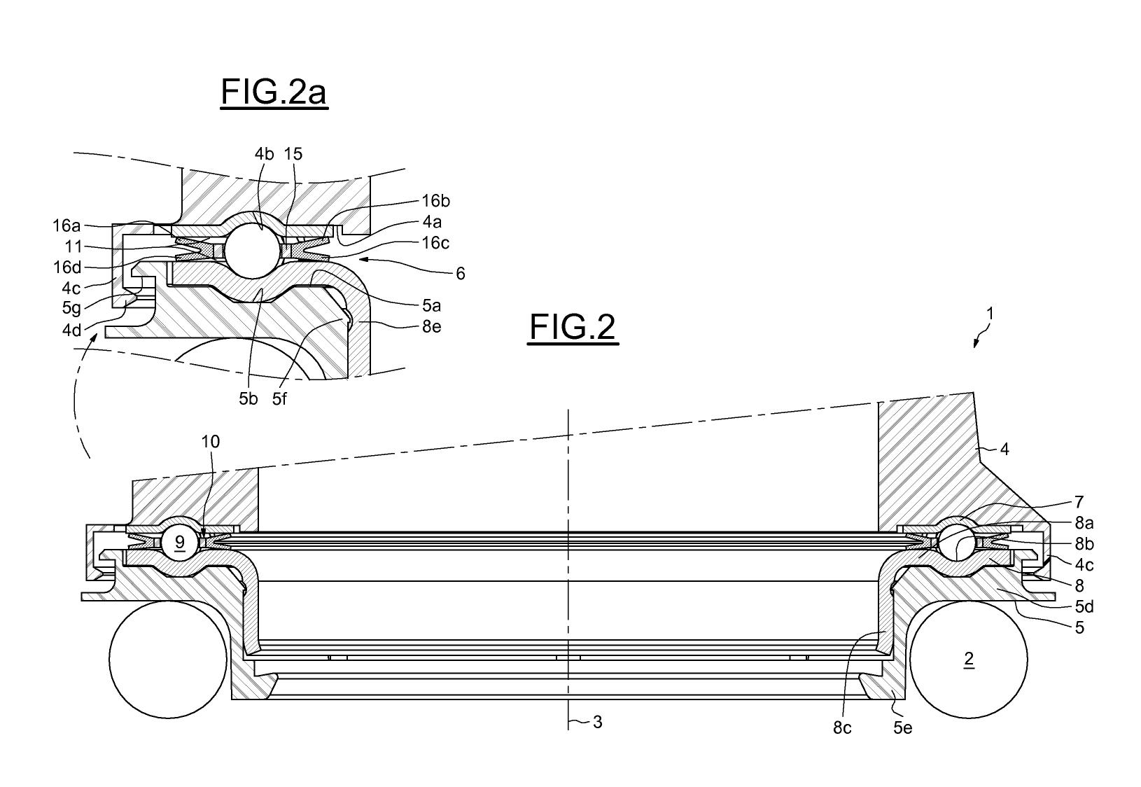

FIG. 2 is a view in axial section of a suspension stop device according to a second embodiment of the invention,

FIG. 2a is a detail of a part situated on the left in FIG. 2,

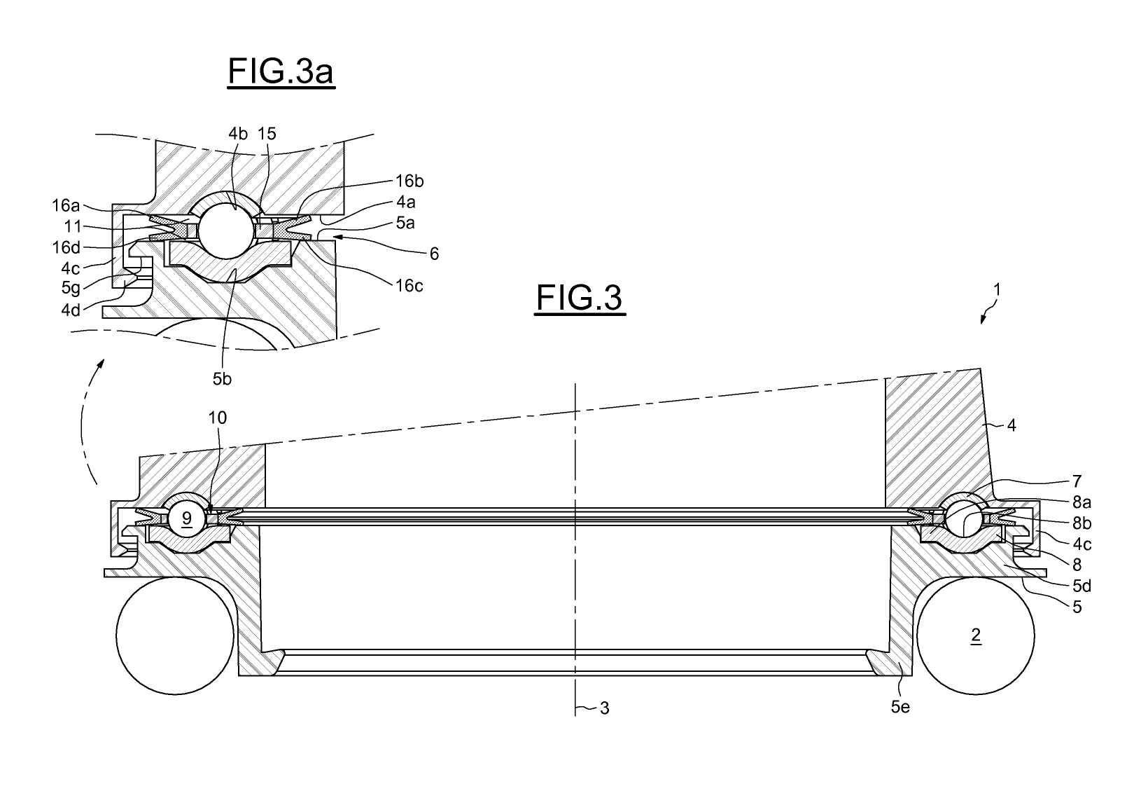

FIG. 3 is a view in axial section of a suspension stop device according to a third embodiment of the invention,

FIG. 3a is a detail of a part situated on the left in FIG. 3,

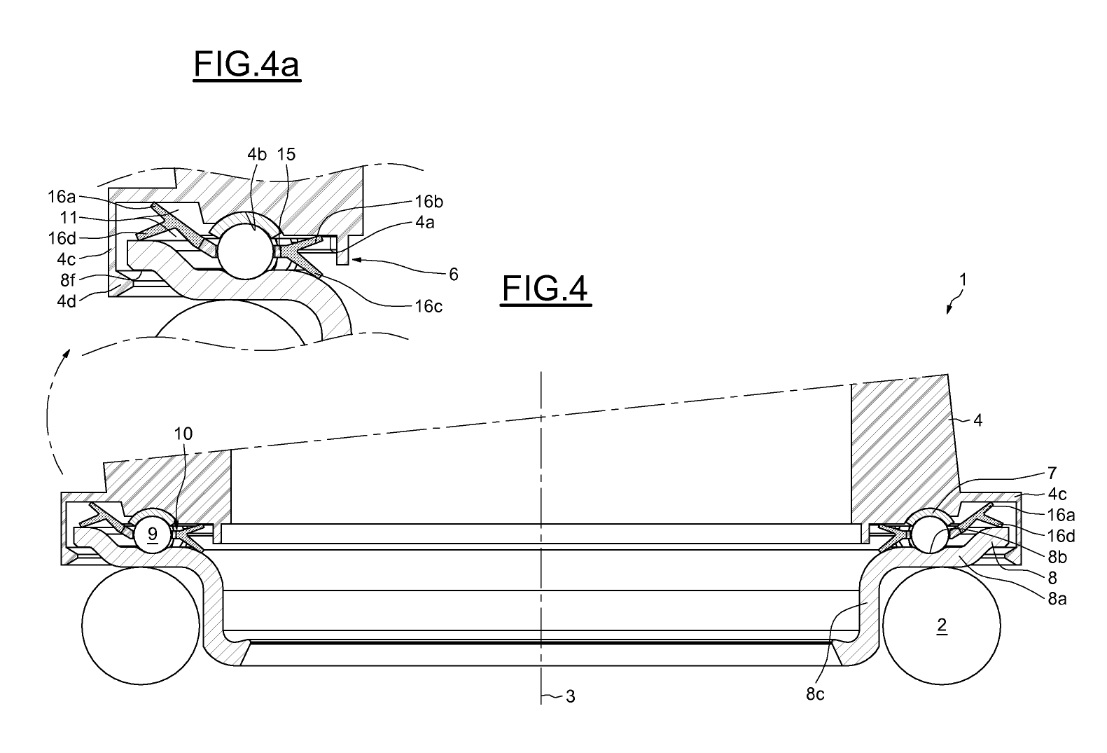

FIG. 4 is a view in axial section of a suspension stop device according to a fourth embodiment of the invention,

FIG. 4a is a detail of a part situated on the left in FIG. 4,

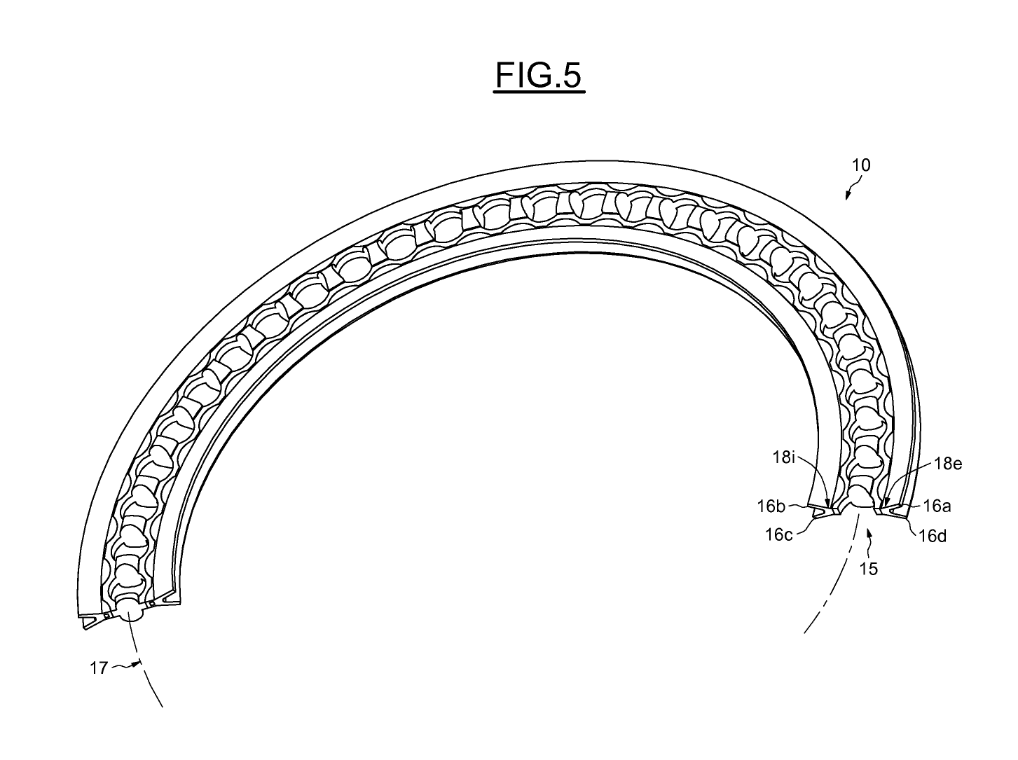

FIG. 5 is a perspective view of a bearing cage of a roller bearing device according to the invention,

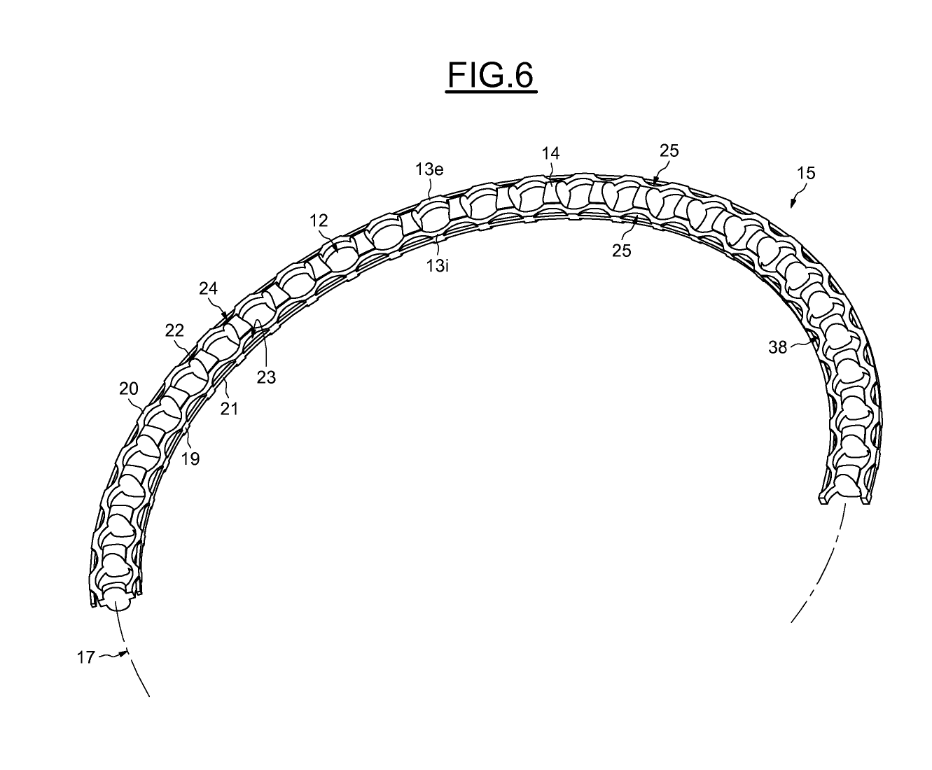

FIG. 6 is a perspective view of a bearing cage frame according to the invention,

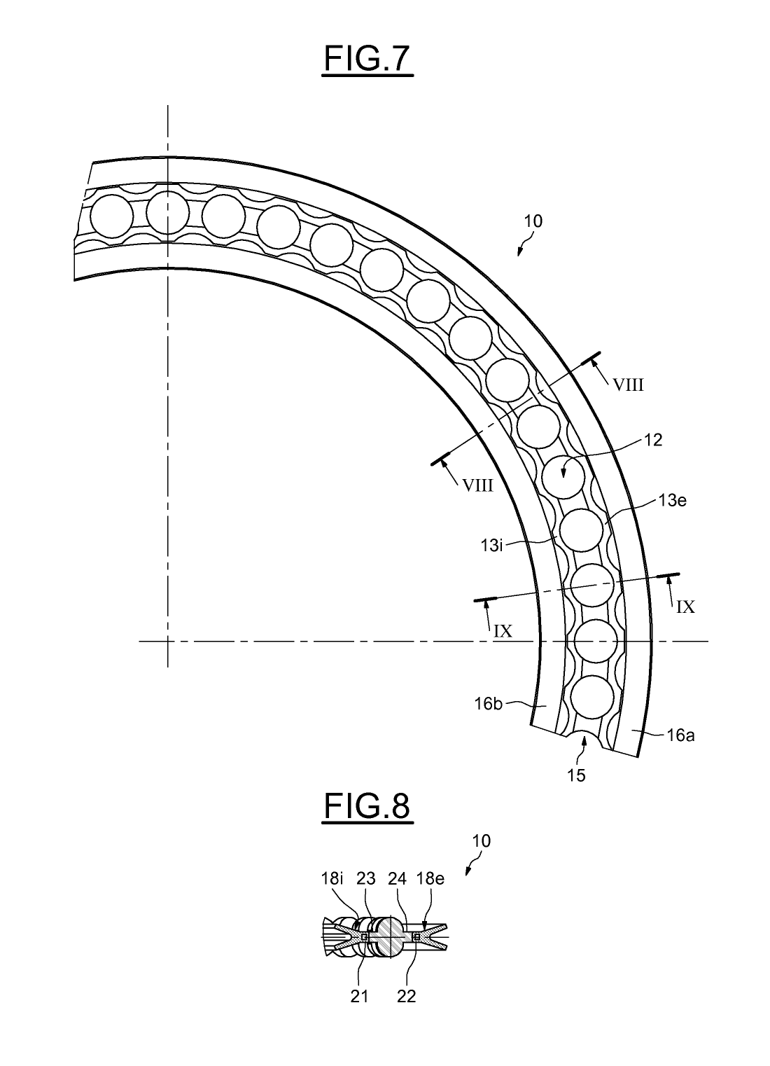

FIG. 7 is an upper view of a bearing cage of a roller bearing device according to the invention,

FIG. 8 is a view along the section VIII-VIII of the cage represented in FIG. 7,

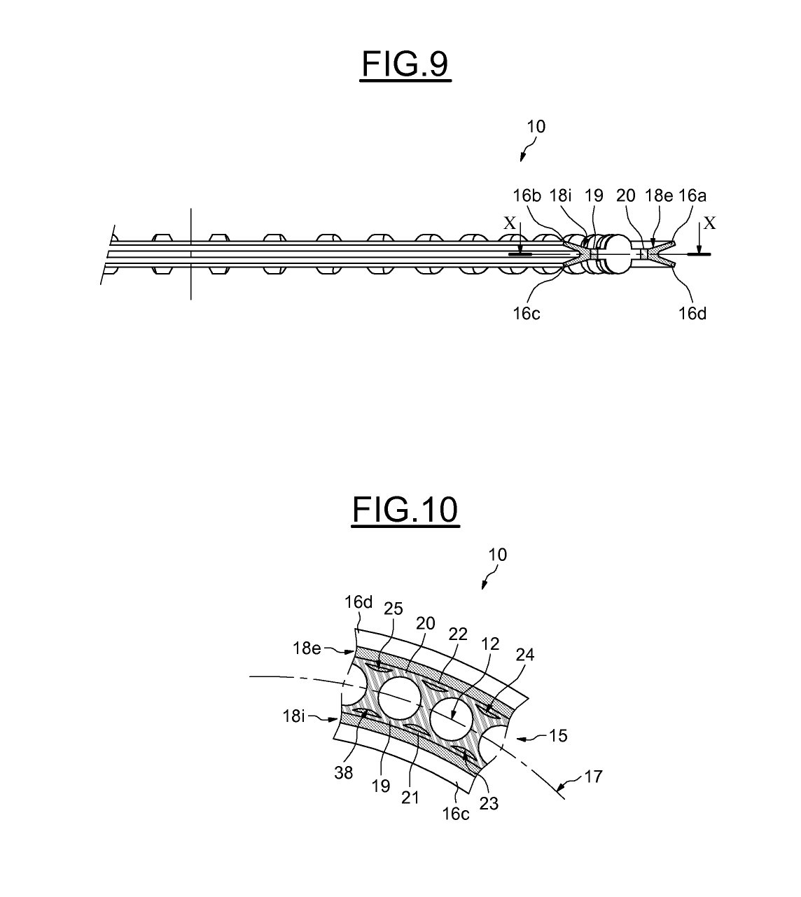

FIG. 9 is a view along the section IX-IX of the cage represented in FIG. 7,

FIG. 10 is a view along the section X-X of the cage represented in FIG. 9,

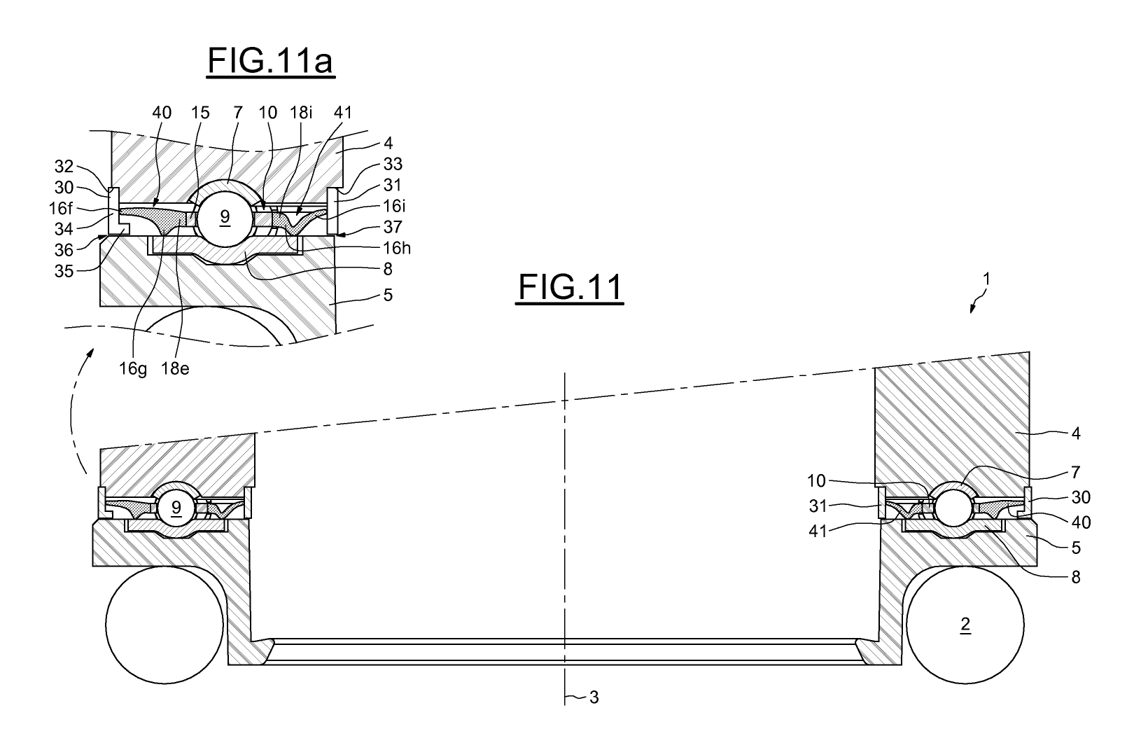

FIG. 11 is a view in axial section of a suspension stop device according to a fifth embodiment of the invention,

FIG. 11a is a detail of a part situated on the left in FIG. 11.

The references cited in the remainder of the description with regard to FIGS. 1, 2, 3, 4, 11 appear in part in their respective detailed views 1a, 2a, 3a, 4a, 11a instead of in FIGS. 1, 2, 3, 4, 11 themselves.

In FIGS. 1 to 4, four different embodiments of the invention have been represented.

As represented in FIG. 1, a suspension stop device, denoted by the general numerical reference 1, is intended for fitting between an upper supporting seat (not represented) suitable for resting, directly or indirectly, in an element of a chassis of the motor vehicle, and a helical-type spring 2. The suspension stop 1 is disposed around a shock absorber rod (not represented) extending along a substantially vertical axis 3, the spring 2 being fitted around the said rod.

The suspension stop 1 principally comprises an upper supporting cap 4, a supporting seat 5, and a roller bearing 6 disposed axially between the upper cap and the supporting seat. The roller bearing 6 comprises an upper race 7 made of pressed plate, a lower race 8 likewise made of pressed plate, and a row of rolling elements, here in the form of balls 9. The upper race 7 is in contact with a lower surface 4a of the upper cap 4, and the lower race 8 is in contact with an upper surface 5a of the supporting seat 5.

The lower race 8 has a dish shape, having a radial part 8a comprising a groove 8b serving as a rolling track for the balls 9, the said radial part resting against the upper face 5a of the supporting seat, and an axial part 8c in the form of a cylindrical skirt slipping inside an axial skirt 5e of the supporting seat 5. The axial part 8c comprises on the face of its outer radius a circumferential groove 8e, which cooperates with a circumferential protuberance 5f of the supporting seat 5, situated on the inner face of the axial skirt 5e of the seat. The race dish 8 is thus held axially in relation to the supporting seat 5.

The roller bearing 6 comprises a cage 10 suitable for keeping the centres of the balls 9 regularly spaced along a bearing circumference, which represents the trajectory of the balls. The cage 10 comprises a rigid frame 15, which surrounds each one of the balls 9 in order to hold it on the bearing circumference, and circumferential lips 16b, 16c, 16d, 16a made of more pliable material than that of the frame.

Each of the lips is in sealing contact, by an annular surface, with a radial surface portion, that is to say a surface portion whose normal is parallel to the axis of the bearing. The lips 16a and 16b, radially on either side of the frame, are in sealing contact with the lower face 4a of the upper cap. The lip 16d, radially on the outside in relation to the frame, is in sealing contact with the upper face 5a of the supporting seat. The lip 16c, radially on the inside in relation to the frame, is in sealing contact with the lower race 8 of the bearing. The lips can be deformed by compression in the contact zone. The leak-tightness is in this case ensured by an annular frictional surface, more specifically a flat, ring-shaped surface, whose normal is parallel to the bearing axis.

The upper cap 4 can consist of a monobloc part made of plastics material, for example of polyamide PA 66 reinforced or not with glass fibres or other mineral fillers. The upper cap has, overall, the shape of a truncated cone pierced by a bore of same axis as the cone. In the lower face 4a of the upper cap is made a circular groove 4b, which allows the upper race 7 of the bearing to be centred.

The supporting seat 5 is a rotary part comprising a radial skirt 5d bearing the upper supporting surface 5a of the bearing. The radial skirt 5d is of external diameter greater than the diameter of the spring 2, the median diameter being that of the helix defined by the centre of the wire of the spring. The radial skirt 5d can thus rest on the upper part of the spring 2. The supporting seat 5 likewise comprises an axial skirt 5e, the external diameter of which is slightly less than the internal diameter of the winding of the spring 2, so as to be able to slip inside the winding.

In the upper face 5a of the supporting seat is made a circular groove 5b, which allows the lower race 8 of the bearing to be centred. The supporting seat 5 can be made of synthetic plastics material, for example in the same material as the upper cap 4, or a different material.

The lower part of the upper cap 4 comprises a circumferential channel 4c covering the upper circumference of the supporting seat 5, including the upper bearing race 7 and an upper part of the lower race 8 of the bearing. The circumferential channel 4c comprises a radial return segment 4d suitable for catching beneath a shoulder 5g of the supporting seat 5.

The circumferential lips 16a, 16b, 16c, 16d of the cage, the upper race 7, the lower face 4a of the upper cap, the lower race 8, and the upper face 5a of the supporting seat define a leak-tight space 11 containing the balls 9 and a lubricant (not represented). The leak-tight space 11, sealed by the annular contact zones of the lips with the lower race, the upper cap or the supporting seat, prevents lubricant leaks towards the outside of the bearing, as well as the entry of pollutants (water, abrasive or non-abrasive particles, other pollutants likely to dilute the lubricant . . . ). This leak-tight space, as illustrated in FIG. 1, protects the upper race 7 from external aggressive elements, allowing protective surface treatments, where necessary, to be carried out only upon the lower race dish 8.

FIG. 5 shows a bearing cage 10 of a roller bearing device according to the invention. The bearing cage comprises an open-work central frame 15 disposed, overall, along a bearing circumference 17. In the plane of the bearing circumference 17, the two lips 16b, 16c are attached to the frame 15 by a layer forming a cling fastening circumference 18i and situated towards the inside of the bearing circumference 17, and the two lips 16a, 16d are attached to the frame 15 by a layer forming a cling fastening circumference 18e and situated towards the outside of the bearing circumference. The lips 16b and 16c diverge and deviate from the plane of the bearing circumference as the axial distance from the bearing circumference widens. The assembly comprising the two lips 16b, 16c and the cling fastening layer 18i forms a split lip, the axial section of which is in the shape of a “V” or “Y”, the cling fastening layer 18i forming the point of the “V” or the foot of the “Y”. The lips 16a and 16d diverge and deviate from the plane of the bearing circumference as the axial distance from the bearing circumference widens. The assembly comprising the two lips 16a, 16d and the cling fastening layer 18e forms a split lip, the axial section of which is in the shape of a “V” or “Y”, the cling fastening layer 18e forming the point of the “V” or the foot of the “Y”. FIG. 6 shows the central frame 15 of the cage 10 of FIG. 5. Elements common to FIG. 5 are found again, the same elements being in this case denoted by the same references. The frame 15 defines a circular string of receptacles 12 of overall spherical shape and intended to each contain a ball 9. Each receptacle 12 is delimited by two intermediate elements 14, extending radially between an inner arc 13i and an outer arc 13e. Proximate to the place where two arcs 13i or two arcs 13e join, the faces opposite to the bearing circumference of the arcs define a concave surface 38. This concave surface 38 delimits a concave zone 25 of the frame. This concave zone 25 is of axial opening, that is to say that it is possible to connect the inside of the concavity and the outside of the frame by following an axial direction. At the places where the receptacles 12 have overall a maximum diameter, the arcs 13i (or 13e) form protuberances 19 (or 20) in relation to the concave zones 25. Each pair of two neighbouring protuberances 19 (or 20) is connected by a mould-on bar 21 (or 22). Each mould-on bar 21 (or 22) defines, with its associated concave zone 25, a cling fastening opening 23 (or 24).

FIGS. 7, 8, 9 and 10 are an upper view and sectional views of the cage of FIG. 5. Elements common to FIGS. 5 and 6 are found again, the same elements being in this case denoted by the same references. It will be noted in FIGS. 8 and 10 that the material of the lips in their circumferential cling fastening region 18i (or 18e) fills the cling fastening openings 23 (or 24), including the mould-on bars 21 (or 22).

The frame 15 of the cage 10, which must be sufficiently rigid to keep the balls equidistant along their rolling path and to avoid warping of the cage in the plane of the balls, can advantageously be produced by moulding of rigid plastics materials such as polyamide, especially polyamide 66, polypropylene, especially polypropylenes with improved fluidity of injection, having a MFI (Melt Flow Index), for example, greater than 30 g/10 min (measurement according to standard ASTM DI238), or polybutylene terephthalate, these polymeric matrices being charged or not with mineral reinforcements, fibres, particles or nanocharges. The Young's moduli at ambient temperature and in the dry state of such materials typically have values within the ranges 2 GPa to 30 GPa. The sealing lips 16a, 16b, 16c, 16d can advantageously be fabricated by overmoulding lips of a thermoplastic elastomer such as TPU or thermoplastic polyurethane onto the cage. Typically, the deformability of these materials can be determined by a stress at 100% of static deformation, which, at ambient temperature, is less than 10 MPa. The facility will then be given to choose a grade of TPU or of other plastics elastomer, the recommended injection temperature of which is less than the melting temperature of the material used to make the frame. It will be noted that, as the inside of the “V” or “Y” of the lips forms a negative draught zone in relation to the axial direction, the removal of such lips from the mould calls for the presence of parts inserted in the mould, and/or a demoulding by deformation, made possible by the pliability of the material used.

FIG. 2 describes an embodiment similar to that of FIG. 1. Elements common to FIG. 1 are found again, the same elements in this case bearing the same references. Contrary to FIG. 1, the upper race 7 of the roller bearing is wider in the radial direction than the cage in its entirety, with the result that the lips 16a and 16b, radially on either side of the frame, are both in sealing contact with the upper race 7 of the roller bearing. The outer extent of the lower race 8 is likewise wider, with the result that the lips 16c and 16d, radially on either side of the frame, are both in sealing contact with the upper race 8 of the roller bearing. The lips 16a, 16b, 16c, 16d of the cage, the upper race 7, the lower race 8, define a leak-tight space 11. In this embodiment, the rubbing of the lips takes place solely on the races 7 and 8 of the bearing, that is to say on a steel surface, whereas for other embodiments, especially that of FIG. 1, at least one of the lips rubs on a plastics surface of the upper cap or of the supporting seat. This embodiment is in this sense particularly advantageous, since it reduces the friction-induced wearing of the elastomeric lips.

FIG. 3 describes an embodiment similar to that of FIG. 1. Elements common to FIG. 1 are found again, the same elements in this case bearing the same references. Contrary to FIG. 1, the lower race 8 is in the form of a flat ring, the whole of the lower surface of which rests against the upper face 5a of the supporting seat 5, the ring being curved by a circumferential groove 8b at the level of its median radius, so as to constitute a rolling track for the balls 9. The lower part of the upper cap 4 comprises a circumferential channel 4c covering the upper circumference of the supporting seat 5, including, in the volume contained beneath the upper cap, the two bearing races 7 and 8 in their entirety. Each of the lips (16a, 16b, 16c, 16d) is in sealing contact, by an annular surface, with a portion of radial surface. The lips 16a and 16b, radially on either side of the frame, are in sealing contact with the lower face 4a of the upper cap. The lips 16c and 16d, radially on either side of the frame, are in sealing contact with the upper face 5a of the supporting seat. In this embodiment, the bearing surfaces of the lips are all strictly radial, with the result that, in case of radial displacement of the cage, the annular contact zone shifts slightly without change of surface or orientation, and the forces between the lips and their antagonistic surfaces are virtually unmodified. As for the illustrative embodiment of FIG. 1, the lips 16a, 16b, 16c, 16d of the cage, the upper race 7, the lower face 4a of the upper cap, the upper face 5a of the supporting seat, the lower race 8, define a leak-tight space 11. In the present embodiment, however, as illustrated in FIG. 3, the leak-tight space fully contains the upper race 7 as well as the lower race 8. By virtue of this configuration, the races 7 and 8 are protected from chemical (corrosion) or mechanical attacks (abrasion) from the environment external to the bearing. The lubricant present in the space 11 allows them to be afforded adequate protection in the absence of specific surface treatments. This configuration is therefore particularly interesting from an economic viewpoint, since it allows the performance of expensive surface treatments upon the races to be avoided.

FIG. 4 presents a fourth embodiment of the invention. In FIG. 4, the same principal elements are found again as in FIGS. 1 to 3, the same elements in this case bearing the same references. As in FIGS. 1 and 2, the lower race 8 is in the shape of a dish, but the external diameter of the axial part 8c of the race is this time complementary with the internal diameter of the spring 2, the lower race 8 also ensuring the working of the supporting seat. Hence the lower part 4a of the upper cap 4 comprises a circumferential channel 4c covering the upper circumference of this lower race 8, including the upper bearing race 7 and an upper part of the lower bearing race 8. The circumferential channel 4c comprises a radial return segment 4d suitable for catching beneath a shoulder 8f of the lower race 8.

The lips 16a, 16b, 16c and 16d are each in sealing contact, by a flat annular surface, with a radial surface portion. The lips 16a and 16b, radially on either side of the frame, are in sealing contact with the lower face 4a of the upper cap, each following an annular contact zone axially offset in relation to the other. The lip 16d, radially on the outside in relation to the frame, is in sealing contact with the upper face 5a of the supporting seat. The lip 16c, radially on the inside in relation to the frame, is in sealing contact with an annular contact surface which lies close to a flat ring and borders a radial surface portion 8a of the lower race 8.

A leak-tight space 11 is delimited by the lips 16b, 16c, 16d, 16a of the cage, the upper race 7, the lower face 4a of the upper cap, and the lower race 8. This leak-tight space, as illustrated in FIG. 4, protects the upper race 7 from external attacks, allowing protective surface treatments, where necessary, to be carried out only upon the lower race dish 8.

FIG. 11 presents a fifth embodiment of the invention. In FIG. 11 the same principal elements are found again as in FIGS. 1 to 4, the same elements in this case bearing the same references. In addition to the elements already described in FIGS. 1 to 4, the bearing of FIG. 4 comprises a cylindrical flange 31 on the inside of the bearing and a flange 30 on the outside of the bearing. The flange 31 is shrunk onto an inner axial surface of the upper cap 4, and rests against a radial shoulder 33 of this axial portion. The flange 30 comprises an axial portion 34, which is shrunk onto an outer axial surface of the upper cap 4, and rests against a radial shoulder 32 of this axial portion. The flange 31 hides a part of the space separating the upper cap 4 and the supporting seat 5 on the inner circumference of the bearing. The axial portion 34 of the flange 30 hides a part of the space separating the upper cap 4 and the supporting seat 5 on the outer circumference of the bearing. A narrow passage 37 is made between the flange 31 and the supporting seat 5. The narrowness of this passage 37 allows the entry of solid particles through the inner circumference of the bearing to be limited. The outer flange 30 comprises a radial return segment 35 which faces the supporting seat 5, making a narrow passage 36 between the flange 30 and the supporting seat 5. The narrowness of this passage 36 allows the entry of solid particles through the outer circumference of the bearing to be limited. The cage 15 still comprises a frame 10 holding the balls 9. A circumferential lip 40 is moulded onto the outer circumference of the frame 10, to which it is fixed by a continuous cling fastening layer 18e. A circumferential lip 41 is moulded onto the inner circumference of the frame 10, to which it is fixed by a continuous cling fastening layer 18i.

As in FIGS. 4 and 4a, the upper race 7 is relatively narrow, so as to make a rolling path for the balls 9, but without offering any friction surface to the lips 40 or 41. As in FIGS. 4 and 4a, the lower race 8 is substantially wider than the upper race 7 in the radial direction, so as to make friction surfaces for the lips 40 and 41.

The lip 40 is a split lip: starting from the cling fastening layer 18e, the lip 40 separates into a first lip 16g forming a substantially axial layer and a second lip 16f forming a substantially radial layer. The end of the lip 16g is in sealing contact with the lower race 8, and the end of the lip 16f is in sealing contact with the inner face of the flange 30. The lip 16g, which rests axial on the inner race 8, therefore exerts a bearing force directed substantially along the plane of the layer of this lip. The stability of the friction force is improved, in relation to lips of whatever orientation, in case of relative misalignment of the two races relative to their common axis.

The lip 41 is an accordion-type or bellows-type lip, since it has a first fold or layer part 16h extending radially towards the bottom of FIG. 11a from the inner cling fastening layer 18i, and a second fold or layer part 16i in the continuation of the first fold 16h and extending radially towards the top of FIG. 11a. The lip 41 is therefore constituted by a single layer, the axial section of which comprises a plurality of substantially rectilinear portions, two of these portions forming an angle less than 60°. With such a single-layer lip, easier to mould than a dual-layer divided lip, two potential sealing surfaces are available, with either two mutually facing surfaces, or two orthogonal surfaces. In this instance, in the embodiment of FIGS. 11 and 11a, the transitional bend between the folds 16h and 16i is in sealing contact with the lower race 8, and the end of the fold 16i is in sealing contact with the face inside the bearing of the inner flange 31.

As in the embodiments of FIGS. 1, 3 and 4, the lips 40 and 41 isolate the upper race from the environment external to the bearing, which allows surface treatments upon this upper race to be spared.

The flanges 30 and 31 allow the prevention of entry of external pollutants, such as projected particles, into the bearing, and form a first protective barrier with respect to the sealing lips 40 and 41. Moreover, the lips, by rubbing on the flange, benefit from an antagonistic friction surface of appropriate hardness and surface roughness, without the need to use an upper bearing race wider than the cage. Savings are thus made on the material consumed to make the races. Construction variants can be envisaged in which all the sealing contacts of the lips are made with inner surfaces of the flanges.

The invention is not confined to the embodiments described and can form the subject of numerous variants. The frame can be made, for example, of low-carbon steel requiring no thermal treatment to obtain sufficient hardness, for example a steel of type DC04, which contains, by way of indication, 0.08% carbon, 0.03% phosphorous, 0.03% sulphur and 0.40% manganese. The sealing lips can in this case be overmoulded out of a thermoplastic elastomer, or out of a traditional cross-linkable elastomer, such as NBR (acryloNitrile Butadiene Rubber) or natural rubber. The materials and the geometries of the upper and lower caps can be different from those described. For example, the split sealing lips could be replaced by lips having a single layer but forming a bellows having two circumferential folds, a first fold of each bellows being in contact with one of the two antagonistic axial surfaces, upper or lower, a second fold of each bellows being in contact with the other of the two antagonistic axial surfaces. The geometry of the rolling elements can be other than spherical (rollers, needles . . . ). The rolling elements can be disposed along a plurality of concentric bearing circumferences, and the frame of the cage can in this case comprise a plurality of concentric rows of receptacles 12, of geometry complementary with these rolling elements.

The contact of one or more circumferential lips, instead of being made with radial surfaces of the bearing, could be made with axial or truncated surfaces, that is to say surfaces whose normal is perpendicular to, or concurrent with, the axis of the bearing. In this latter case, in order to limit the risks of unbalancing the friction forces in case of radial misalignment of the races of the bearing, the facility will be given to choose a small angle (for example less than 45°, or better still, less than 30°) between the normal to the mean plane of the lip in the contact zone, and the normal local to the surface on which this lip rubs.

Configurations can likewise be envisaged in which one or more lips of the cage do not, strictly speaking, rub on a surface opposite, but define with this same a narrow zone or labyrinth ensuring adequate leak-tightness. The pliability of the lips then allows the parasite frictions to be limited should the lips nevertheless come to rub on the surface opposite.

Finally, the principle of a race having overmoulded sealing lips according to the preceding description can be transposed to roller bearings having concentric races between which are disposed rolling elements resting radially on each of the races. In this case, the sealing lips will extend in a substantially axial direction of the bearing, and the moulding concavities 25 will remain of axial opening. For example, FIGS. 1a, 2a, 3a, 4a can be interpreted as axial sectional views of possible embodiments of such bearings, by regarding these figures as relating to a bearing of horizontal revolution axis in relation to the figure, instead of the vertical revolution axis of the first part of the description.

The roller bearing cage according to the invention allows a good leak-tightness of the bearing to be obtained by virtue of the local pliability of the lip seal, allows production costs to be reduced by limiting the number of parts to be assembled by virtue of the integration of the seals with the race, and allows a long-lasting sealing contact to be had, the wearing of the lips being compensated by the elastic opening of the “V” of the divided lip. The bearing contact of the lips upon radial surfaces of the axial bearing allows a bearing to be obtained having good tolerance to the relative misalignment of the two races relative to their common axis.

The intertwining of the materials of the cage and of the race prevents the sealing lip from separating from the cage and remaining stuck, for example, to one of the races. In certain configurations of the invention, the races can successfully be totally isolated from the external environment by virtue of the seal, which allows costly surface treatments of the races to be spared.

1. A cage for holding rolling elements of a roller bearing, comprising:
a frame part holding the rolling elements on a bearing circumference, and
at least one circumferential sealing lip extending from the frame, and wherein,
the at least one circumferential sealing lip is made of a more pliable material than the material of the frame, and wherein,
the frame has concave surfaces that define concavities of an axial opening, and
the material of the circumferential lip at least partly fills the concavities defined by the concave surfaces.

2. The cage according to claim 1, further comprising:
at least one circumferential sealing lip extending from the frame towards one of an inside and outside of the bearing circumference, and wherein,
the frame is axially traversed by orifices disposed on one of an inside circumference inside and an outside circumference of the bearing circumference, and wherein
the orifices are at least partly filled by the material used to form the circumferential lip.

3. The cage according to claim 1, formed by molding at least one circumferential lips over the frame.

4. The cage according to claim 1, wherein the frame further comprises:
intermediate elements separating the rolling elements and two groups of lateral elements holding the rolling elements on the bearing circumference, and wherein
the cage comprises provides one of at least one split lip and a lip having a plurality of 25 folds fixed by a continuous fastening layer to one of the groups of lateral elements.

5. The cage according to claim 1, wherein the fastening layer is substantially radial and separates into two distinct lips.

6. The cage according to claim 1, wherein one of the two lips extends in a substantially axial direction.

7. The cage according to claim 4, in which wherein the fastening layer extends radially towards one of the inside and outside of the bearing circumference, forming a lip having a plurality of circumferential folds.

8. The cage according to claim 1, wherein the material of the circumferential lip(s) is a thermoplastic elastomer, and wherein,
the melting temperature of the thermoplastic elastomer is less than that of the material used to form the frame.

9. The cage according to claim 1, wherein the frame is made of material having a matrix of at least one of a polyamide, polybutylene terephthalate and polypropylene, and
the circumferential lips are made of thermoplastic polyurethane.

10. The cage according to claim 8, comprising a metal frame and one or more circumferential lip(s) made of one of a thermoplastic elastomer and cross-linkable elastomer.

11. A roller bearing for a motor vehicle suspension stop device, comprising
an upper race,
a lower race,
rolling elements between the two races, resting axially on each of the races and travelling on these same,
a holding cage for the rolling elements,
a frame holding the rolling elements on a bearing circumference,
at least one circumferential sealing lip extending from the frame, and wherein,
the at least one circumferential sealing lip is made of a more pliable material than the material of the frame, and wherein,
the frame has concave surfaces that define concavities of an axial opening, and
the material of the circumferential lip at least partly fills the concavities defined by the concave surfaces.

12. A motor vehicle suspension stop device, comprising:
an upper cap, fixedly connected to the chassis of the vehicle,
a supporting seat resting one of directly or and indirectly on a spring of the vehicle suspension, and
a roller bearing interposed between the upper cap and the supporting seat, and
the roller bearing providing,
an upper race,
a lower race,
rolling elements between the two races, resting axially on each of the races and travelling on the same,
a holding cage for the rolling elements,
a frame holding the rolling elements on a bearing circumference,
at least one circumferential sealing lip extending from the frame, and wherein,
the at least one circumferential sealing lip is made of a more pliable material than the material of the frame, and wherein,
the frame has concave surfaces that define concavities of an axial opening, and
the material of the circumferential lip at least partly fills the concavities defined by the concave surfaces.
